(19) United States
(12) Patent Application Publication
(10) Pub. No.: US 2021/0400944 A1
(43) Pub. Date: Dec. 30, 2021

(54) INSECT TRAP

(71) Applicant: SEOUL VIOSYS CO., LTD., Ansan-si (KR)

(72) Inventor: Gwang-ryong LEE, Ansan-si (KR)

(21) Appl. No.: 16/625,513

(22) PCT Filed: Jun. 22, 2018
(86) PCT No.: PCT/KR2018/007062

§ 371 Date: Dec. 20, 2019

(30) Foreign Application Priority Data
Jun. 23, 2017 (KR) 10-2017-0079512
Jun. 23, 2017 (KR) 10-2017-0079525

(51) Int. Cl. A01M 1/08

(52) U.S. Cl. CPC A01M 1/08; A01M 2200/012

(57) ABSTRACT

An insect trap includes: a light source for emitting light which attracts insects; a blower disposed adjacent to the light source; a housing including an air inlet and an air outlet and receiving the blower; a trap fastened to the housing on the side of the air outlet; a cover which covers the light source and is fastened to the housing; and a first waterproof member provided between the housing and the cover.

### CROSS REFERENCE TO RELATED APPLICATION

This application is a National Stage Entry of International Application No. PCT/KR2018/007062, filed on Jun. 22, 2018, and claims priority from and the benefit of Korean Patent Application Nos. 10-2017-0079512, filed on Jun. 23, 2017 and, 10-2017-0079525, filed on Jun. 23, 2017, each of which is hereby incorporated by reference for all purposes as if fully set forth herein.

### BACKGROUND

### Field

Exemplary embodiments/implementations of the invention relate generally to an insect trap and, more specifically, to an insect trap adapted to attract and capture insects using light.

### Discussion of the Background

Generally, flying insects, such as flies, mosquitoes, and moths, are infectious vectors carrying various kinds of germs and cause direct or indirect damage to humans or crops.

Although various pesticides and insecticides have been used to eliminate such harmful insects, there is a problem in that such pesticides and insecticides are harmful to the human body and cause ecological imbalance. As an alternative, various methods, such as development of biodegradable insecticides, use of natural enemies or pheromones, and application of insecticide after attraction of insects, have been studied.

The above information disclosed in this Background section is only for understanding of the background of the inventive concepts, and, therefore, it may contain information that does not constitute prior art.

### SUMMARY

Embodiments of the present invention provide an insect trap having high efficiency and reliability in insect trapping.

Additional features of the inventive concepts will be set forth in the description which follows, and in part will be apparent from the description, or may be learned by practice of the inventive concepts.

In accordance with one aspect of the present invention, an insect trap includes: a light source part emitting light attracting insects; a blowing unit disposed adjacent to the light source part; a housing including an air inlet and an air outlet and receiving the blowing unit; a trap unit fastened to the housing at a side of the air outlet; a cover fastened to the housing and covering the light source part; and a first waterproof member disposed between the housing and the cover.

In one embodiment, the blowing unit may include a fan disposed under the light source part; and a first insect passage unit disposed between the fan and the light source part and including a frame defining a through-hole through which insects pass, and the through-hole may occupy an area of 20% to 99% of a total area of the first insect passage unit in plan view.

The through-hole may have an inscribed circle having a maximum diameter greater than an average size of the insects. In addition, the frame may include protrusions protruding into the through-hole. The inscribed circle of the through-hole may have a maximum diameter of 12 mm or less and may have a diameter of 7 mm to 12 mm.

In one embodiment, the through-hole may be provided in plural and the first insect passage unit may include a through-hole portion in which the through-holes are formed and a central portion in which the through-holes are not formed, and the central region may be disposed corresponding to a center of rotation of the fan.

In one embodiment, the insect trap may further include a second insect passage unit disposed between the fan and the trap unit and including a through-hole through which insects pass. The second insect passage unit may have a different shape from the first insect passage unit. In the second insect passage unit, the through-hole may occupy an area of 50% to 99% of a total area of the second insect passage unit in plan view.

In one embodiment, the first waterproof member may have a closed-figure shape disposed along an end of the housing.

In one embodiment, the insect trap may further include: a light source support on which the light source part is mounted, the light source support being fastened to the housing at a side of the air inlet; and a second waterproof member disposed between the housing and the light source support. The second waterproof member may have a closed-figure shape disposed along an end of the light source support.

In one embodiment, the light source part may include: a light source unit including at least one light source emitting the light and a substrate on which the light source is mounted; a light source case receiving the light source unit; and a light source cover covering the light source case.

In one embodiment, the light source case may have an interior space open at one side thereof to receive the light source unit, and the light source cover may support the substrate and include a first spacer separating the substrate from the light source cover. The first spacer may separate the light source unit from a rear surface of the light source support by a predetermined distance.

In one embodiment, the light source part may emit the light in a lateral direction of the housing and the distance may be set to allow the light to be emitted at a maximum angle.

In one embodiment, the light source cover may further include a second spacer protruding from a rear surface thereof and maintaining a separation distance between the light source cover and the light source case.

In one embodiment, the light source unit may further include a connector disposed on the substrate and connecting the light source to an interconnect line. The light source cover may further include a shield protruding from the rear surface of the light source cover and covering the connector. The shield may include a UV blocking agent.

In one embodiment, the blowing unit may include a fan forcing air having passed through the air inlet to flow towards the air outlet.

Embodiments of the present invention provide an insect trap having high efficiency and reliability in insect trapping.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a perspective view of an insect trap according to one embodiment of the present invention.

FIG. 2 is an exploded perspective view of the insect trap shown in FIG. 1.

FIG. 3 is a perspective view of a housing according to one embodiment of the present invention.

FIG. 4 is a perspective view of a light source part.

FIG. 5A is an exploded perspective view of the light source part shown in FIG. 4 and FIG. 5B is a bottom perspective view of a light source cover shown in FIG. 5A.

FIG. 6A, 6B, and FIG. 6C are a longitudinal sectional view, a transverse sectional view and a plan view of the light source part shown in FIG. 4, respectively.

FIG. 7 is a perspective view of a light source support and the light source part.

FIG. 8A is a side view of FIG. 7 and FIG. 8B is a top view of FIG. 7.

FIG. 9 is an exploded perspective view of a blowing unit.

FIG. 10A, 10B, 10C, 10D, and FIG. 10E are plan views of upper insect passage units according to embodiments of the present invention.

FIG. 11 is a plan view of a lower insect passage unit according to another embodiment of the present invention.

FIG. 12 is an exploded perspective view of a trap unit.

FIG. 13A and FIG. 13B are side views of an insect trap having a typical light source part and an insect trap according to one embodiment of the present invention, respectively.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, embodiments of the present invention will be described with reference to the accompanying drawings. It should be understood that the present invention may be embodied in various ways and is not limited to the following embodiments, and that various modifications, changes, alterations, and equivalent embodiments can be made by those skilled in the art without departing from the spirit and scope of the invention.

Hereinafter, embodiments of the present invention will be described in detail with reference to the accompanying drawings.

An insect trap according to embodiments of the invention is adapted to trap insects outdoors. However, the insect trap may be used indoors. When used indoors, the insect trap may be disposed at various places including the ceiling, walls, floor, and the like.

As used herein, although spatially relative terms such as “upper,” “lower,” “lateral”, and the like are defined with reference to a certain component, it should be understood that directions referred to herein are defined for convenience of description and may be interpreted as different directions according to rotation or arrangement of a device.

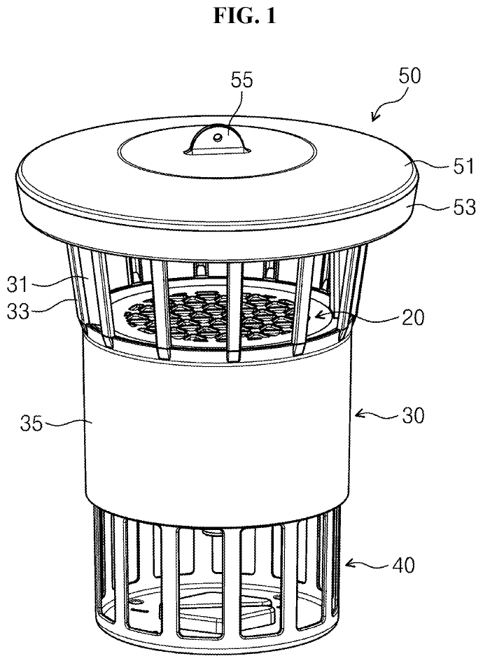

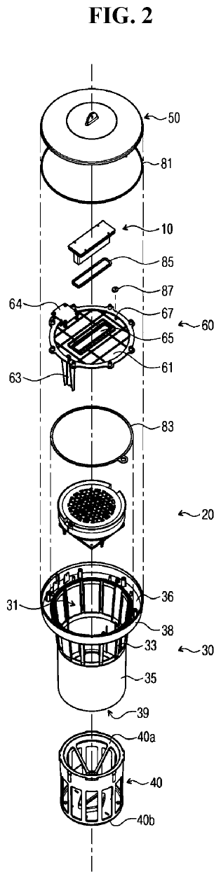

FIG. 1 is a perspective view of an insect trap according to one embodiment of the present invention and FIG. 2 is an exploded perspective view of the insect trap shown in FIG. 1. In FIG. 1 and FIG. 2, it should be noted that some components (for example, a mesh unit of a trap unit) are omitted for convenience of description.

Referring to FIG. 1 and FIG. 2, the insect trap according to the embodiment includes a housing 30 defining an external appearance of the insect trap, a cover 50 covering one side of the housing 30, a light source part 10 received in the housing 30 and emitting light for attracting insects, a blowing unit 20 disposed adjacent to the light source part 10, a trap unit 40 disposed adjacent to the blowing unit 20 and fastened to the housing 30, and a waterproof member preventing inflow of water into some regions inside the insect trap. The light source part may be supported by a light source support 60 fastened to the cover 50.

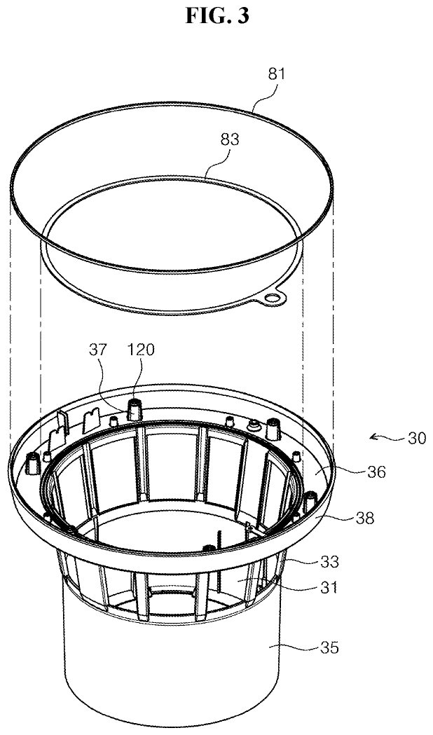

FIG. 3 is a perspective view of the housing 30 according to one embodiment of the present invention. In FIG. 3, some waterproof members are also shown for convenience of description.

Referring to FIG. 1, FIG. 2, and FIG. 3, the housing 30 defines an external appearance of the insect trap and has an interior space which receives the light source part (light source) 10, the blowing unit (blower) 20, and the like. The housing 30 has an air inlet 31 through which air flows into the interior space and an air outlet 39 through which air is discharged from the interior space through the trap unit.

In one embodiment, the housing 30 may have a cylindrical shape open at opposite ends thereof. However, it should be understood that the housing 30 is not limited thereto and may have various shapes in consideration of application of the insect trap, the kind of insect trap, the kinds of insects to be trapped thereby, and the like. In the following embodiments, the housing 30 having a cylindrical shape is illustrated by way of example.

The housing 30 may include a main body 35 having a pipe shape, ribs 33 disposed at an upper portion of the housing 30 and connected to the main body 35 to form an air inlet 31 through which insects enter the housing 30, and a fastening unit 38 provided to upper portions of the ribs 33 and fastened to the cover 50. The housing 30 is fastened at one end thereof to the cover 50 and the air inlet 31 is formed at one side of the housing 30. The housing 30 has an air outlet 39 formed at the other end thereof connected to a trap unit 40.

The main body 35 receives the blowing unit 20 therein and the trap unit 40 is fastened to a lower side of the main body 35.

The ribs 33 are provided in plural and may be connected to an upper portion of the main body 35 in a perpendicular direction of the main body such that the air inlet 31 is formed between adjacent ribs 33. However, it should be understood that the shape of the ribs 33 is not limited thereto and may be modified in various ways so long as ensuring formation of the air inlet 31 therebetween.

The fastening unit 38 is connected to the upper portions of the ribs 33. The fastening unit 38 may be provided in a ring shape corresponding to shapes of the cover 50 and the light source support 60. The fastening unit 38 may have a step portion 36 formed on an inner surface thereof. The step portion 36 is a portion of the fastening unit 38, which is fastened to the light source support 60, and the waterproof member is provided between the light source support 60 and the fastening unit 38. The waterproof member will be described below.

With this structure, the ribs 33 can ensure formation of the air inlet 31 as much as possible while stably supporting the main body 35, the cover 50 and the light source support 60.

In one embodiment, the main body 35, the ribs 33, and the fastening unit 38 may be integrally formed with one another in the housing 30 so as not to be separated from one another. In another embodiment, the main body 35, the ribs 33, and/or the fastening unit 38 may be individually manufactured and assembled to one another.

According to the embodiment of the invention, insects may be introduced into the interior space of the housing 30 through the air inlet 31 formed on a side surface of the housing 30. The shape and size of the air inlet 31 may be modified in various ways in consideration of the kind, size and flying type of insects to be attracted by the insect trap. In particular, the shape or size of the air inlet 31 may be modified to allow light emitted from the light source part 10 to be discharged from the housing as much as possible.

The cover 50 is mounted on an upper end of the housing 30. The cover 50 may have any shape corresponding to the shape of the housing 30. The cover 50 may be detachably mounted on the housing 30.

The cover 50 completely covers an upper portion of the housing 30. The cover 50 may be formed in a substantially flat shape. The cover 50 has a rim partially extending in a downward direction to face the fastening unit 38 of the housing 30 and to be fastened thereto through a fastening member. The cover 50 may be secured to the fastening unit 38 of the housing 30 by at least one fastening member. The fastening member may include a hook, a screw, an insertion groove and protrusion, and the like, and the fastening unit 38 may be fastened to the housing 30 using such a fastening member in various ways.

In one embodiment, the shape of the cover 50 corresponds to the shape of the upper end of the housing 30. For example, the fastening unit 38 may have substantially the same diameter as the housing 30.

The cover 50 may be provided at an upper side thereof with a ring 55 to hold the insect trap.

In one embodiment, a first waterproof member 81 may be disposed between the cover 50 and the fastening unit 38 of the housing 30.

The first waterproof member 81 is formed along the upper end of the housing 30. The first waterproof member 81 may have substantially the same size and shape as the upper end of the housing 30. In addition, since the housing 30 is fastened at one end thereof to the rim of the cover 50, the first waterproof member 81 has substantially the same size and shape as the rim of the cover 50. The first waterproof member 81 is disposed between the rim of the cover 50 and the upper end of the housing 30 and directly contacts the rim of the cover 50 and the upper end of the housing 30.

In this embodiment, the housing 30 has a cylindrical shape and thus has a circular end. Thus, the first waterproof member 81 may also have a circular shape corresponding to the end of the housing 30.

The first waterproof member 81 has a closed-figure shape so as to seal the interior of the cover 50 when the cover 50 is fastened to the housing 30. For example, the first waterproof member 81 may have an O-ring shape.

The first waterproof member 81 may be formed of a resilient material having ductility. The first waterproof member 81 formed of the resilient material is compressed by the end of the housing 30 and the cover 50 to separate the interior defined by the cover 50 and the housing 30 from the outside upon fastening the cover 50 to the housing 30 through screw fastening. With this structure, the first waterproof member 81 prevents intrusion of moisture into the interior defined by the cover 50 and the housing 30. Here, moisture includes not only moisture contained in air but also rain.

The resilient material for the first waterproof member 81 may include a silicone resin, without being limited thereto. The first waterproof member 81 may be formed of any resilient material ensuring that the first waterproof member 81 can stably seal the cover 50 and the housing 30. For example, the resilient material may include natural or synthetic rubbers and other polymeric organic resilient materials.

The light source support 60 is a component on which the light source part 10 is mounted, and serves to stably secure the light source part 10 in the insect trap while preventing intrusion of moisture into the light source part 10 as much as possible. The light source support 60 is disposed between the air inlet 31 and the cover 50.

The light source support 60 is placed on the step portion 36 formed on the fastening unit 38 of the housing 30 and is fastened to the housing 30 through various fastening members. The fastening members fastening the light source support 60 to the housing 30 may include hooks, screws, insertion grooves and protrusions, and the like. A second waterproof member 83 is disposed between the light source support 60 and the housing 30.

The second waterproof member 83 is disposed between the step portion 36 of the housing 30 and the light source support 60 and directly contacts an upper surface of the step portion 36 of the housing 30 and a rear surface of the light source support 60 when the housing 30 is assembled to the light source support 60. In other words, the step portion 36, the second waterproof member 83, and the light source support 60 are sequentially stacked inside the housing 30.

The second waterproof member 83 may have substantially the same size and shape as the step portion 36 of the housing 30. Likewise, the first waterproof member 81 may have substantially the same size and shape as the periphery of the rear surface of the light source support 60.

In one embodiment, the housing 30 has a cylindrical shape, the step portion 36 of the housing 30 has a hollow circular shape, and the light source support 60 has a circular shape overlapping the step portion 36 of the housing 30 to close an open portion of the step portion 36 of the housing 30.

The second waterproof member 83 has a closed-figure shape so as to separate and seal a space defined by the cover 50, the housing 30 and the light source support 60 from the outside when the light source support 60 is fastened to the step portion 36 of the housing 30. For example, the second waterproof member 83 may have an O-ring shape.

Like the first waterproof member 81, the second waterproof member 83 may be formed of a resilient material having ductility. The second waterproof member 83 formed of the resilient material is compressed by the step portion 36 of the housing 30 and the light source support 60 to separate the space defined by the cover 50, the housing 30 and the light source support 60 from the outside upon fastening the housing 30 to the light source support 60 through screw fastening. With this structure, the second waterproof member 83 prevents intrusion of moisture into the interior space.

The resilient material for the second waterproof member 83 may include a silicone resin, without being limited thereto. The second waterproof member 83 may be formed of any resilient material ensuring that the second waterproof member 83 can stably seal the cover 50 and the housing 30. For example, the resilient material may include natural or synthetic rubbers and other polymeric organic resilient materials.

The light source support 60 is provided with an opening 65 through which the light source part 10 is inserted into and fastened to the light source support 60. The light source part 10 is inserted into the opening 65 in a downward direction so as to protrude downwards from the rear surface of the light source support 60.

The light source support 60 may be formed with an interconnect withdrawal opening 67 through which an interconnect line passes through upper and lower surfaces of the light source support 60. The interconnect withdrawal opening 67 may be provided with a third waterproof member 87 that surrounds the interconnect withdrawal opening 67. The third waterproof member 87 may have any shape and size so long as the third waterproof member 87 can seal the interconnect withdrawal opening 67 excluding portions thereof corresponding to the interconnect lines.

Like the first and second waterproof members 81, 83, the third waterproof member 87 may be formed of a resilient material having ductility, for example, a silicone resin, without being limited thereto. The third waterproof member 87 may be formed of any resilient material ensuring that the third waterproof member 87 can stably seal the cover 50 and the housing 30.

The light source part 10 is inserted into an opening 65 of the light source support 60 and may emit light having wavelengths capable of attracting insects. The wavelengths of light attracting insects may differ depending upon the kind of insect. With the structure wherein the light source part 10 emits light having wavelengths capable of attracting insects and the wavelengths of light attracting insects differs depending upon the kind of insect, the insect trap can selectively capture insects through regulation of the wavelengths of light. The light source part 10 will be described below.

The light source support 60 may be fastened to the light source part 10 by a hook, a screw, an insertion groove and protrusion, and the like. A fourth waterproof member 85 may be disposed between the light source support 60 and the light source part 10.

The fourth waterproof member 85 is disposed between a light source case 210 of the light source part 10 and the light source support 60 to be placed along the periphery of the opening 65 of the light source support 60 into which the light source part 10 is inserted. When the light source part 10 is assembled to the light source support 60, the fourth waterproof member 85 directly contacts a rear surface of an upper plate of the light source case 210 and an upper surface of the light source support 60. In other words, the fourth waterproof member 85 is provided to the upper surface of the light source support 60 along the periphery of the light source support 60 and the upper plate of the light source case 210 of the light source part 10 is placed on the fourth waterproof member 85.

The fourth waterproof member 85 may have a larger size than the opening 65 of the light source support 60 and have substantially the same size and shape as the upper plate of the light source case 210.

Here, the fourth waterproof member 85 has a closed-figure shape so as to separate and seal a space defined by the cover 50, the housing 30 and the light source support 60 from the outside when the light source part 10 is fastened to the light source support 60. For example, the fourth waterproof member 85 may have an O-ring shape. In one embodiment, since the light source case 210 has a rectangular shape in plan view, the fourth waterproof member 85 may be provided in a rectangular ring shape corresponding to the shape of the opening 65.

Like the waterproof members described above, the fourth waterproof member 85 may be formed of a resilient material having ductility. The fourth waterproof member 85 formed of a resilient material having ductility is compressed by the step portion 36 of the housing 30 and the light source support 60 to separate the space defined by the cover 50, the housing 30, and the light source support 60 from the outside upon fastening the housing 30 to the light source support 60 through screw fastening. With this structure, the fourth waterproof member 85 prevents intrusion of moisture into the interior space.

The resilient material for the fourth waterproof member 85 may include a silicone resin, without being limited thereto. The fourth waterproof member 85 may be formed of any resilient material ensuring that the fourth waterproof member 85 can stably seal the cover 50 and the housing 30. For example, the resilient material may include natural or synthetic rubbers and other polymeric organic resilient materials.

The blowing unit 20 is disposed under the light source part 10. The blowing unit 20 forces air to flow from the air inlet 31 to the air outlet 39.

The trap unit 40 collects insects introduced into the insect trap by the blowing unit 20. The trap unit 40 is disposed under the blowing unit 20 and is mounted on the other end of the housing 30. The trap unit 40 is provided with a trapping space in which insects are trapped and an inlet through which the insects are introduced into the trapping space. At least a portion of the trap unit 40 may be formed in a mesh shape so as to allow air supplied from the blowing unit 20 to be discharged from the housing.

With the aforementioned structure, the insect trap has a waterproof structure preventing intrusion of moisture into the light source part 10 and achieves improvement in durability. In particular, since the light source part 10 is provided with electrical components to supply electric power to light sources 311, it is difficult to ensure reliability of the light source part 10 when moisture enters the light source part 10. However, according to embodiments of the present invention, the light source part 10 is inserted into the light source support 60 such that an upper portion of the light source part 10 is placed inside the space defined by the housing 30, the cover 50 and the light source support 60, and the waterproof members are provided between the housing 30 and the cover 50, between the housing 30 and the light source support 60 and between the light source support 60 and the light source part 10, respectively, to prevent intrusion of moisture into the light source part 10. Specifically, the first waterproof member 81 is disposed between the housing 30 and the cover 50, the second waterproof member 83 is disposed between the housing 30 and the light source support 60, and the fourth waterproof member 85 is disposed between the light source support 60 and the light source part 10 to block gaps between these components through which moisture can enter the light source part. In addition, the third waterproof member 87 is provided to the interconnect withdrawal opening 67 on the light source support 60, thereby preventing intrusion of moisture into the light source part 10 therethrough.

Accordingly, the insect trap according to this embodiment can prevent corrosion of the interior components, for example, electronic elements, due to moisture, thereby prevent electrical failure caused thereby. As a result, the insect trap according to this embodiment has high waterproof reliability to be used both indoors and outdoors. In particular, the insect trap according to this embodiment can prevent malfunction and failure due to rain when used outdoors.

Next, each component of the insect trap according to embodiments of the present invention will be described in more detail.

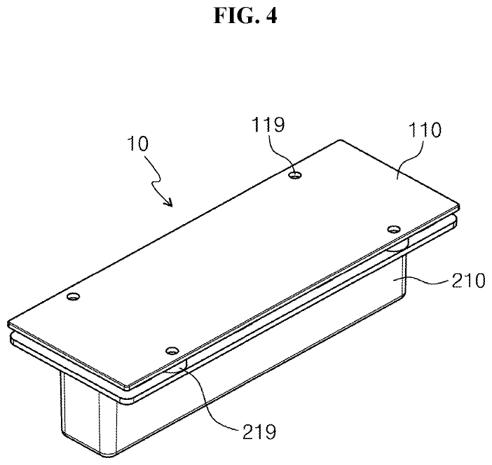

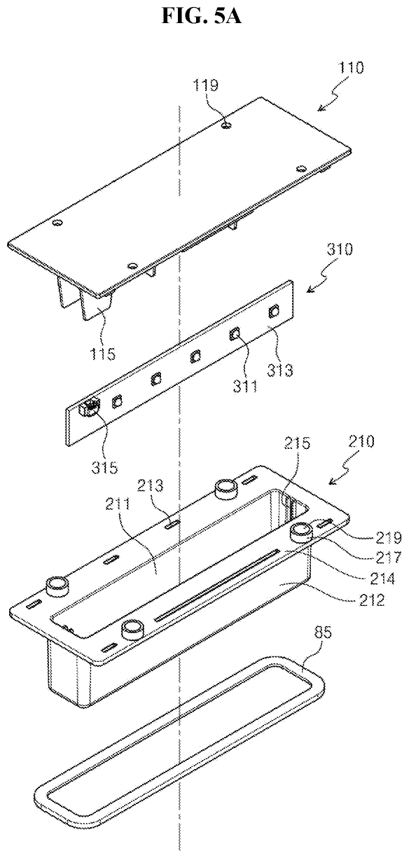

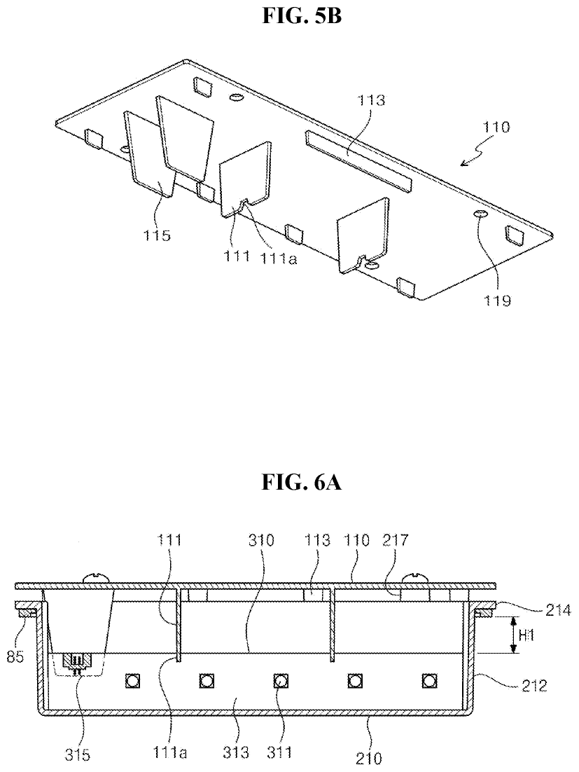

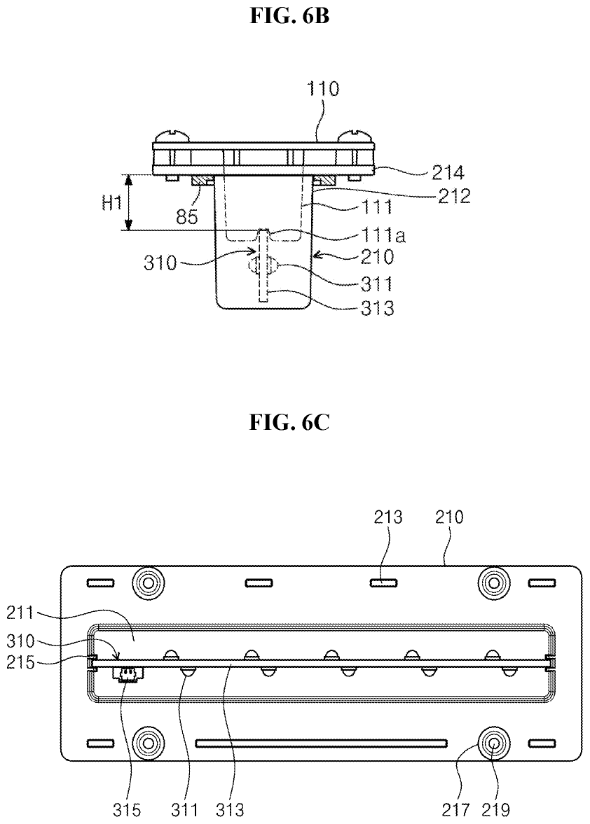

FIG. 4 is a perspective view of the light source part. FIG. 5A is an exploded perspective view of the light source part shown in FIG. 4 and FIG. 5B is a bottom perspective view of a light source cover shown in FIG. 5A. FIG. 6A to FIG. 6C are a longitudinal sectional view, a transverse sectional view and a plan view of the light source part shown in FIG. 4, respectively. In FIG. 6C, the light source cover is not shown for convenience of description.

Referring to FIG. 4 to FIG. 6C, the light source part 10 according to one embodiment includes a light source unit 310 emitting light attracting insects, the light source case 210 receiving the light source unit 310, and a light source cover 110 covering the light source case 210.

In some embodiments, the light source part 10 may be configured to emit light in the form of sheet light or spot light to attract insects. In one embodiment, the light source part 10 may emit light in the form of sheet light or spot light and the following description will be given of the light source part 10 emitting light in the form of spot light.

The light source unit 310 includes a substrate 313 and at least one light source 311 mounted on the substrate 313.

The substrate 313 may have a plate shape extending in a certain direction.

The substrate 313 may be provided on at least one surface thereof with at least one, for example, a plurality of light sources 311 arranged in a certain direction. The plurality of light sources 311 may be arranged in various shapes including a linear shape, a zigzag shape, and the like.

In a structure wherein the plurality of light sources 311 is arranged on both surfaces of the substrate 313, the light sources 311 are disposed so as not to overlap each other. With a structure wherein the light sources 311 are disposed at different locations on both surfaces of the substrate 313, the substrate 313 can have improved heat dissipation effects. However, it should be understood that arrangement of the light sources 311 is not limited thereto and may be modified in various ways.

The light sources 311 emit light in the UV wavelength band. The light sources 311 may emit light in a wavelength band, for example, light in the UV wavelength band, which insects prefer. When light in the UV wavelength band is emitted from the light sources 311, the light may have a wavelength of, for example, 320 nm to about 400 nm. In the light source unit including the plurality of light sources 311, the light sources 311 may emit light in the same wavelength band or in different wavelength bands. For example, in one embodiment, each of the light sources 311 may emit light in the UV wavelength band. In another embodiment, some light sources 311 may emit light in some UV wavelength bands and the remaining light sources 311 may emit light in the other UV wavelength bands. By way of example, some light sources 311 may emit light in a wavelength band of about 320 nm to about 400 nm and the remaining light sources 311 may emit light in a different UV wavelength band. In the structure wherein the light sources 311 emit light in different wavelength bands, the light sources 311 may be arranged in various sequences.

In one embodiment, each of the light sources 311 may emit light in a wavelength band for attracting insects and light in a wavelength band for sterilization or inactivation of insects or viruses. According to this embodiment, the insect trap may emit light having a sterilization function in order to minimize proliferation of viruses due to corpses of insects trapped therein. For example, the light source 311 may emit light in the UVC wavelength band, that is, in a wavelength band of about 100 nm to about 280 nm.

However, it should be understood that the present invention is not limited thereto. In other embodiments, the light sources may emit light not only in the UV wavelength band but also in the visible wavelength band. For example, it is known in the art that flies and rice insects prefer light having a wavelength of about 340 nm or about 575 nm, and moths and mosquitoes prefer light having a wavelength of about 366 nm. In addition, it is known in the art that light in the visible light wavelength band, for example, white, yellow, red, green and blue light, has insect attraction activity. Thus, according to the present invention, the light sources may emit light having various wavelengths so long as light emitted from the light sources can stimulate and attract insects, without being limited to the above embodiments.

In one embodiment, the light sources 311 may emit light in a specific wavelength band and may include light emitting diodes (LEDs), without being limited thereto.

The light source unit 310 may further include a connector 315 disposed on the substrate 313 and connecting the light sources 311 to interconnect lines. The interconnect lines (for example, power source interconnect lines) may be connected to the light source unit 310 through the connector 315.

The light source unit 310 is received in the light source case 210. The light source case 210 protects the substrate 313 and the light sources 311.

The light source case 210 has an interior space open at one side thereof to receive the light source unit 310 therein. In one embodiment, the light source case 210 is open at an upper side thereof such that the light source unit 310 can be received in the light source case 210 in a vertical direction thereof. The light source case 210 includes a receiving portion 212 adapted to receive the light source unit 310 and inserted into the opening 65 of the light source support 60, and an upper plate 214 disposed on an upper side of the receiving portion 212.

The receiving portion 212 may have a size suitable for insertion into the opening of the light source support 60. That is, the light source case 210 may have substantially the same size as or a slightly smaller size than the opening of the light source support 60 in plan view.

An inner wall of the receiving portion 212 is provided with a fastening member, to which the substrate 313 of the light source unit 310 is fastened. In one embodiment, the light source unit 310 may be slidably fastened to the receiving portion 212 and a slit 215 may be formed on the receiving portion 212 to allow the light source 311 to slide thereon.

The upper plate 214 extends from the upper side of the receiving portion 212 in an outward direction and has a width such that the upper plate 214 can be caught by the upper surface of the light source support 60 when the light source case 210 is mounted on the light source support 60.

The light source cover 110 is disposed on an upper side of the light source case 210 to cover the light source unit 310 and the light source case 210. The light source cover 110 serves to prevent foreign matter, particularly moisture, from entering the light source unit 310.

The light source cover 110 may be formed in a plate shape having a size and shape capable of completely covering the light source case 210 in plan view.

The light source cover 110 has first spacers 111, which separate the substrate 313 of the light source unit 310 from the light source cover 110 by a predetermined distance H1. The first spacers 111 protrude downwards from a rear surface of the light source cover 110. The first spacers 111 have a length to be inserted into the interior space of the light source case 210 when the light source cover 110 is received in the light source case 210, and contact an upper surface of the substrate 313 of the light source unit 310 upon insertion of the light source cover 110. The first spacers 111 allow the substrate 313 to be placed in the light source case 210 by pressing the substrate 313 in a downward direction. The first spacer 111 is formed with an insertion groove 111a into which the substrate 313 is fitted, whereby the light source unit 310 can be stably secured inside the light source case 210.

The light source cover 110 has second spacers 113, which separate the upper plate 214 of the light source case 210 from the light source cover 110 by a predetermined distance. The second spacers 113 protrude downwards from the rear surface of the light source cover 110. The second spacer 113 may have a smaller length than the first spacer 111 and the light source cover 110 is separated a predetermined distance from the upper plate 214 of the light source case 210 along the second spacer 113. The structure wherein the light source cover 110 is separated from the upper plate 214 of the light source case 210 by the second spacers 113 allows heat generated from the light source unit 310 to be effectively discharged to the outside. Here, the upper surface of the upper plate 214 of the light source case 210 may be formed with grooves 213 corresponding to the second spacers 113 of the light source cover 110. The grooves 213 of the upper plate 214 serve to hold the second spacers 113 in place and may have a smaller depth than the length of the second spacers 113.

In addition, the light source cover 110 may be provided with shields 115 protruding from the rear surface of the light source cover 110 and covering the connector 315. The shields 115 may be provided in pair to shield the connector 315 at opposite sides of the substrate 313 and the connector 315 mounted on the substrate 313. The height of the shields from the rear surface of the light source cover 110 may differ depending upon the location of the connector 315. The connector 315 receives electric power through an interconnect line to supply the electric power to the light sources 311 and can suffer from discoloration, deformation, and cracking upon continuous exposure to light. The shields 115 effectively prevent light emitted from the light sources 311 from being directly delivered to the connector 315, thereby preventing generation of such problems. To this end, the shields 115 may be formed of an opaque material or may be formed by depositing opaque layers on the surface of the light surface cover. In one embodiment, when light emitted from the light source 311 comprises light in the UV wavelength band, the shields 115 may be formed of a material containing a UV blocking agent to block UV light or may further include a layer formed of the material containing the UV blocking agent.

In one embodiment, although not shown in the drawings, the shields 115 may protrude from an inner surface of the light source case 210 or from a lower surface of the light source case 210 instead of the light source cover 110. In this structure, the shields 115 may be integrally formed with the light source case 210.

The connector 315 may be at least partially formed of a polymer material. Although UV light can cause easy deformation of the polymer material, the shields 115 can prevent deformation of the connector 315 as much as possible in this embodiment.

In one embodiment, the light source cover 110 is fastened to the light source case 210 through a fastening member. The fastening member may include a hook, a screw, an insertion groove and protrusion, and the like. In one embodiment, the light source cover 110 may be coupled to the light source unit 310 by screws. The light source cover 110 and the light source case 210 are provided at corresponding locations thereof with screw holes 119, 219 into which the screws are inserted through rotation. Here, one of the light source cover 110 and the light source case 210 is formed with screw protrusions 217 to separate the light source cover 110 from the light source case 210. The screw protrusion 217 may have a height corresponding to a separation distance between the light source cover 110 and the light source case 210 and may be formed at a center thereof with a screw hole 219 into which a screw is inserted through rotation.

In one embodiment, the light source case 210 is formed of a transparent insulation material and serves to protect the light sources 311 and the substrate 313 while allowing light emitted from the light sources 311 to pass therethrough.

In one embodiment, the light source case 210 may have a roughness on the surface thereof to allow light emitted from the light sources 311 to be discharged to the outside through effective dispersion and/or scattering. The roughness of the light source case 210 may be formed in some regions or in the entire region of an inner surface and/or an outer surface thereof.

The light source case 210 may be formed of various materials so long as the light source case can satisfy the aforementioned functions, without being limited to a particular material. For example, the light source case 210 may be formed of quartz or an organic polymer material. Here, the organic polymer material may be selected in consideration of the wavelength of light emitted from the light sources 311 since an absorption/transmission wavelength of the organic polymer material differs depending upon the kind of monomer, formation method, and formation conditions. For example, organic polymers, such as poly(methyl methacrylate) (PMMA), polyvinyl alcohol (PVA), polypropylene (PP), and low density polyethylene (PE), substantially do not absorb UV light, whereas an organic polymer such as polyester can absorb UV light.

In one embodiment, the light source case 210 is not limited to the above shape and may have various shapes corresponding to the shape of the insect trap. In addition, although the light source unit 310 is provided singularly in the above embodiments, it should be understood that the present invention is not limited thereto. The insect trap may include two or more light source units 310 and the number of light sources 311 and/or the number of substrates 313 in each of the light source units 310 may be changed in various ways.

The light source case 210 is provided at a lower side thereof with the fourth waterproof member 85. The fourth waterproof member 85 is provided to a rear surface of the upper plate 214 of the light source case 210. The fourth waterproof member 85 is provided in a rectangular O-ring shape and the receiving portion 212 of the light source case 210 is inserted into a ring portion of the fourth waterproof member 85.

In one embodiment, the light source part 10 may emit light in one direction. In the structure wherein the light sources 311 are disposed on one surface of the substrate 313 as shown in the drawings, light can be emitted therefrom in a direction perpendicular to the surface of the substrate on which the light sources 311 are disposed. However, the direction of light emitted from the light source part 10 may be changed in various ways.

Although the light source part 10 is provided singularly in the above embodiments, it should be understood that the present invention is not limited thereto. The insect trap may include two or more light source parts 10 and the number of individual light emitting diodes in each of the light source parts 10 may be changed in various ways.

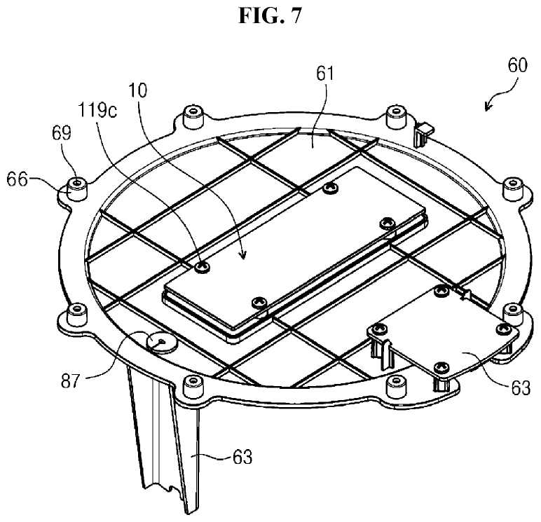

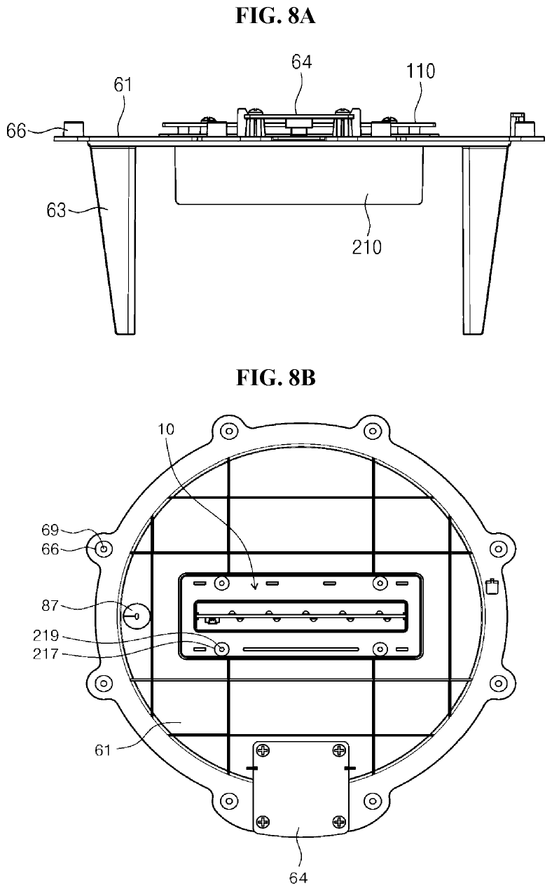

FIG. 7 is a perspective view of the light source support and the light source part, in which the light source part is seated on the light source support. FIG. 8A is a side view of FIG. 7 and FIG. 8B is a top view of FIG. 7.

Referring to FIG. 7, FIG. 8A, and FIG. 8B, the light source part 10 is mounted on the light source support 60. The light source part 10 is inserted into the opening of the light source support 60. As a result, in the light source case 210, the substrate is disposed perpendicularly to the rear surface of the light source support 60 and a longitudinal direction of the substrate is parallel to the rear surface of the light source support 60. Light emitted from the light source part 10 travels in a direction parallel to the rear surface of the light source support 60 and in a direction oblique thereto. The traveling direction of light emitted from the light source part 10 will be described below.

The light source support 60 may include a circular plate 61, which can be perpendicularly assembled to the housing 30 (see FIG. 2) in the longitudinal direction of the housing 30, and a leg 63 protruding downwards from the plate 61. The leg 63 may be provided in plural and may be fastened to the main body 35 of the housing 30 such that the light source support 60 can be stably secured to the main body 35. In one embodiment, the light source support may include two legs 63.

In one embodiment, the legs 63 of the light source support 60 and the main body 35 of the housing 30 may be respectively formed with protrusions and slits, or vice versa, which are disposed to face each other to be slidably fastened to each other. With this structure, the light source support 60 may be slidably inserted into the main body 35 of the housing 30 through an upper side thereof in the downward direction.

The plate 61 of the light source support 60 may be provided with a screw protrusion 66 fastened to the step portion 36 of the housing 30 and formed at a center thereof with a screw hole 69 into which a screw is inserted through rotation.

The light source support 60 is provided with a printed circuit board 64 for driving at one side of an upper surface of the plate 61 to drive the light source part 10. The printed circuit board 64 for driving may be connected to the light source unit 310 of the light source part 10 through an interconnect line (not shown). Specifically, the printed circuit board 64 for driving may be connected to each of the light sources through the connector of the light source unit 310. In addition, a drive unit may be electrically connected to a blowing unit 20 (see FIG. 2) through an interconnect line at a lower side thereof to control a blowing amount through control of a fan of the blowing unit 20. The blowing unit 20 is connected to the drive unit through the interconnect withdrawal opening. As described above, the interconnect withdrawal opening is provided with the second waterproof member 83, which protects the light source part 10 from water.

Although not shown in the drawings, the printed circuit board 64 for driving may be provided at a lower side thereof with a switch (not shown) adapted to control supply of electric power to the light source part 10 and an additional waterproof member surrounding the switch. However, it should be understood that the switch is not limited to this location and may be disposed at various locations depending upon the shape and utility of the insect trap.

In one embodiment, the light source support 60 may include a photocatalyst layer containing a photocatalyst material on the rear surface thereof. The photocatalyst material generates photocatalytic reaction by light emitted from the light source part and may include titanium oxide (TiO₂), zinc oxide (ZnO), tin oxide (SnO₂), and the like.

The photocatalyst layer may be formed as a separate layer on the surface of the light source support 60 or may be contained in a material for formation of the light source support 60.

A photocatalyst can react with light in various wavelength bands depending upon materials constituting the photocatalyst. In one embodiment, the photocatalyst layer may be formed of a photocatalyst material capable of generating photocatalytic reaction by light in the UV wavelength band among various wavelength bands. However, it should be understood that the kind of photocatalyst is not limited thereto and other photocatalysts having the same or similar mechanism may be used depending upon light emitted from the light source part. The photocatalyst is activated by UV light to generate chemical reaction and to decompose various contaminants and viruses in air contacting the photocatalyst through redox reaction. Sterilization, purification and deodorization of air can be achieved through such photocatalytic reaction. In particular, sterilization can ensure antibacterial activity by destroying enzymes in fungal cells and enzymes acting on the respiratory system and can prevent growth of bacteria and fungi while decomposing toxins generated therefrom.

In one embodiment, the photocatalyst layer may be a titanium oxide layer. Upon irradiation of titanium oxide with UV light, carbon dioxide is generated, thereby improving an effect of attracting insects. The titanium oxide layer may be formed in any region without limitation so long as light emitted from the light source part 10 can reach the region, and may be formed over the entirety of the rear surface of the light source support 60 or only in some regions thereof.

In one embodiment, the titanium oxide layer may be formed not only on the rear surface of the light source support 60 but also in other regions where light emitted from the light source part reaches. For example, the titanium oxide layer may be formed on an upper surface of the blowing unit 20, specifically, on an upper surface of an insect passage unit.

In one embodiment, the light source support 60 may have a roughness on the rear surface thereof to ensure effective dispersion and/or scattering of light emitted from the light source part. The roughness of the light source support 60 may be formed in some regions or in the entire region of the rear surface of the light source support. Further, in some embodiments, the roughness may be formed not only on the rear surface of the light source support 60 but also in some regions of other components, which can be irradiated with light emitted from the light source part, in order to ensure effective dispersion and/or scattering of the light. For example, the roughness may be formed on the upper surface of the blowing unit 20, specifically on an upper surface of an insect passage unit, an inner wall of the housing, and the like.

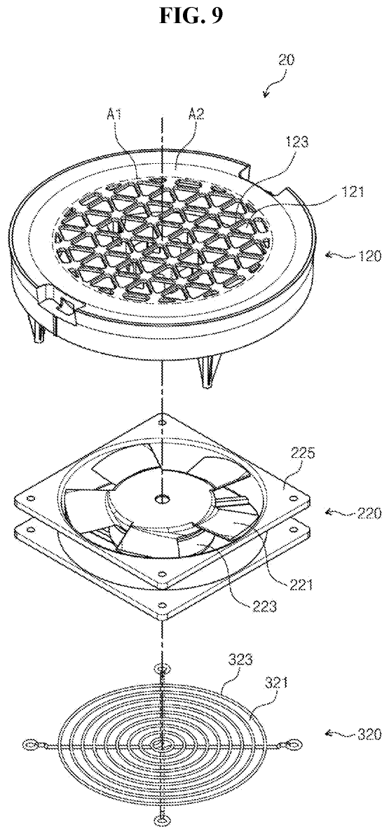

The blowing unit is disposed under the light source part and FIG. 9 is an exploded perspective view of the blowing unit.

Referring to FIG. 9, the blowing unit 20 forces air supplied through a side surface of the housing 30 (see FIG. 2) to flow in the downward direction.

The blowing unit 20 may include a fan 220 and the insect passage unit provided to at least one side of upper and lower sides of the fan 220. In one embodiment, the insect passage unit includes an upper insect passage unit 120 disposed above the fan 220 and a lower insect passage unit 320 disposed below the fan 220.

The upper insect passage unit 120 is disposed between the light source part 10 (see FIG. 2) and the fan 220, and the lower insect passage unit 320 is disposed between the fan 220 and the trap unit 40 (see FIG. 2). The upper insect passage unit 120 and the lower insect passage unit 320 are fastened to each other by fastening members, with the fan 220 interposed therebetween. The fastening members may include hooks, screws, insertion grooves and protrusions, and the like, and the upper insect passage unit 120, the lower insect passage unit 320 and the fan may be fastened to one another using such fastening members in various ways.

The upper insect passage unit 120 and the lower insect passage unit 320 are disposed to overlap the fan 220 in plan view. In one embodiment, the upper insect passage unit 120 and the lower insect passage unit 320 may have the same diameter as or a larger diameter than the fan 220.

The upper insect passage unit 120 includes a through-hole portion A1, through which air and insects pass, and a surrounding portion A2 surrounding the through-hole portion A1 and fastened to other components.

The through-hole portion A1 is provided with a plurality of through-holes 121 through which air is forced to pass by rotation of the fan under the upper insect passage unit 120 and through which insects pass together with the air flow. Adjacent through-holes 121 are connected to each other by frames 123 connected to the surrounding portion A2. In other words, the through holes 121 formed in the upper insect passage unit 120 have various shapes defined by the frames 123.

The through-hole portion A1 may have various shapes in plan view. In one embodiment, the size of the through-hole portion A1 may be set corresponding to the size of the fan 220 under the through-hole portion. For example, the through-hole portion A1 may have substantially the same diameter as the fan 220 or a slightly greater diameter or slightly smaller diameter than the fan 220. The size of the through-hole portion A1 may be changed in various ways depending upon the flux of air or the flow speed of air by the fan 220, the size of insects, and the like. The surrounding portion A2 is provided with fastening members fastened to the housing, the fan, and the lower insect passage unit 320. The surrounding portion A2 may not be formed with the through-holes 121.

The through-holes 121 may have various shapes, such as a circular shape, an elliptical shape, a polygonal shape, and the like in plan view. In the embodiment shown in FIG. 9, the through-holes 121 have a substantially triangular shape and are arranged to be adjacent to each other. However, it should be understood that the shape of the through-holes 121 is not limited thereto.

Each of the through-holes 121 may have an inscribed circle having a maximum diameter of about 12 mm or less in plan view. The maximum diameter of the inscribed circle may be determined in consideration of the flux of air passing through the through-hole 121, an average size of insects to be trapped by the insect trap, flying characteristics of the insects, and the like. In one embodiment, the inscribed circle of the through-hole 121 may have a maximum diameter of about 10 mm or less.

If the inscribed circle of the through-hole 121 has a diameter of greater than about 10 mm or about 12 mm, insects can be scattered through collision with the fan 220 after passing through the through-hole 121, since the insects cannot pass through the fan 220 disposed under the through hole 121. In this case, the scattered insects can be attached to the fan 220 and surrounding components to make the insect trap unclean, instead of being trapped by the insect trap. In addition, upon assembly or disassembly of the insect trap, an object having a larger size than insects can directly contact the fan. However, the through-holes 121 having an inscribed circle having a diameter of 12 mm or less can prevent such problems.

In each of the through-holes 121, the inscribed circle may have a minimum diameter of about 1 mm, about 5 mm, or about 7 mm or more in plan view. The minimum diameter of the inscribed circle may be determined depending upon whether insects can pass through the through-holes 121 of the insect passage unit 120, and may be set in various ways depending upon the size of insects or behavior characteristics thereof.

In one embodiment, the through-holes 121 may occupy an area of about 20% to about 99% of the total area of the upper insect passage unit 120 in plan view. In another embodiment, the through-holes 121 may occupy an area of about 40% to about 95% of the total area of the upper insect passage unit 120 in plan view. Herein, the area occupied by the through-holes 121 means a ratio of the area of the through-holes 121 to the total area of the through-hole portion A1 and the surrounding portion A2. Herein, the ratio of the area of the through-holes 121 to the total area of the through-hole portion A1 may range from about 10% to about 99% in plan view.

In the upper insect passage unit 120, if the area of the through-hole portion A1 is less than about 40% or about 20% of the total area of the upper insect passage unit 120, it is difficult for insects to pass through the upper insect passage unit 120 and the amount of air passing therethrough is also small, thereby causing deterioration in insect trapping efficiency. On the contrary, if the area of the through-hole portion A1 is about 95% or more or about 99% or more of the total area of the upper insect passage unit 120, the frames 123 cannot sufficiently cover the fan 220 and fails to secure sufficient protection with respect to the fan 220, and it can be difficult to guide air to travel towards the air inlet of the trap unit.

In plan view, each of the frames 123 may have various thicknesses and shapes. An eddy can be generated between the frames 123 and the fan 220 depending upon the shape of the frames 123, thereby improving insect trapping efficiency.

The fan 220 includes a motor 223 and a plurality of blades 221 connected to the motor 223. The plural blades 221 are rotated about a rotational axis of the motor 223 to force air to flow in the downward direction. When the fan is rotated by the motor 223, the air introduced into the housing through the air inlet disposed above the blowing unit 20 flows towards the air outlet disposed below the blowing unit 20. However, it should be understood that the shape of the fan 220 is not limited thereto and any well-known fan 200 having various shapes may be used so long as the fan can generate the flow of air. In one embodiment, the insect trap may further include a protective member 225, which surrounds the blades 221 to prevent the blades 221 from being exposed to the outside.

The lower insect passage unit 320 is disposed at a location corresponding to the upper insect passage unit 120, with the fan 220 interposed therebetween. Like the upper insect passage unit 120, the lower insect passage unit 320 is provided with a plurality of through-holes 321 through which air is forced to pass by rotation of the fan disposed above the lower insect passage unit 320 and through which insects pass together with the air flow. Adjacent through-holes 321 are connected to each other by frames 323.

The lower insect passage unit 320 may have various shapes so long as the lower insect passage unit is formed with the through-holes 321. In one embodiment, the lower insect passage unit 320 may have a different shape from the upper insect passage unit 120. In this embodiment, the lower insect passage unit 320 is formed in a net shape having a concentric circle.

However, it should be understood that the shape of the lower insect passage unit 320 is not limited thereto. In another embodiment, the lower insect passage unit 320 may have the same shape as the upper insect passage unit 120. Further, in the lower insect passage unit 320, the ratio of the area of the through-holes 321 to the total area of the lower insect passage unit 320 may be substantially in the same range as that of the upper insect passage unit 120.

The through-holes 321 of the lower insect passage unit 320 may have various shapes. In one embodiment, each of the through-holes 321 of the lower insect passage unit 320 may have an inscribed circle having a maximum diameter of about 12 mm or less, about 10 mm or less, or about 7 mm or less, in plan view. In each of the through-holes 321 of the lower insect passage unit 320, the inscribed circle may have a minimum diameter of about 3 mm, about 5 mm, or about 7 mm or more in plan view. The minimum diameter of the inscribed circle may be determined depending upon whether insects can pass through the through-holes 321 of the insect passage unit 320, and may be set in different ways depending upon the size of insects or behavior aspects thereof.

In plan view, each of the frames 323 constituting a film of the lower insect passage unit 320 may have various thicknesses and shapes. An eddy can be generated between the frames 323 and the fan 220 depending upon the shape of the frames 323, thereby improving insect trapping efficiency.

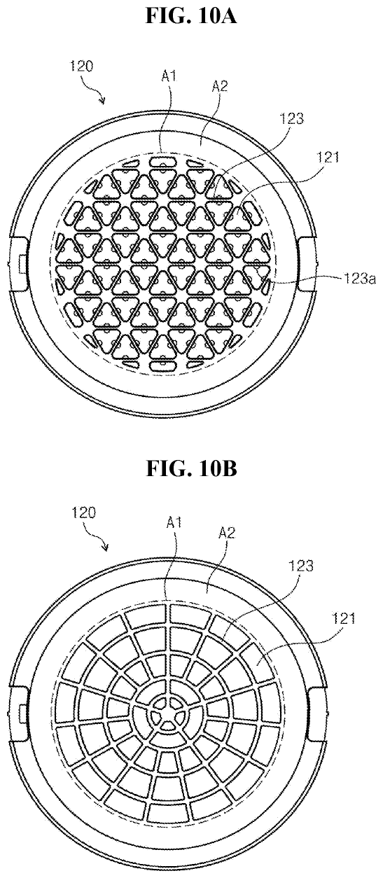

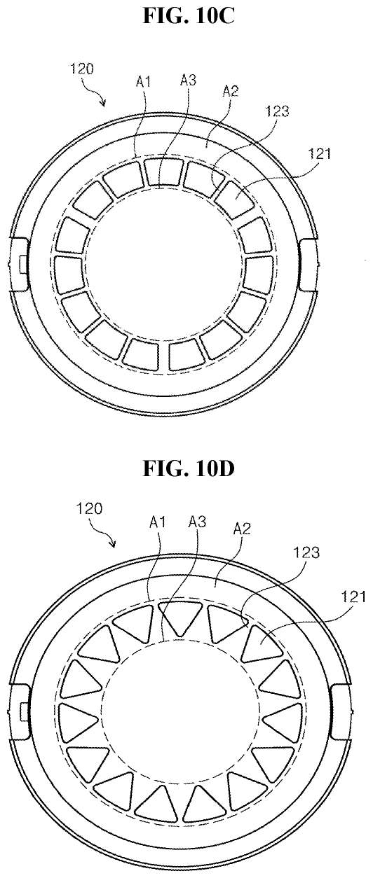

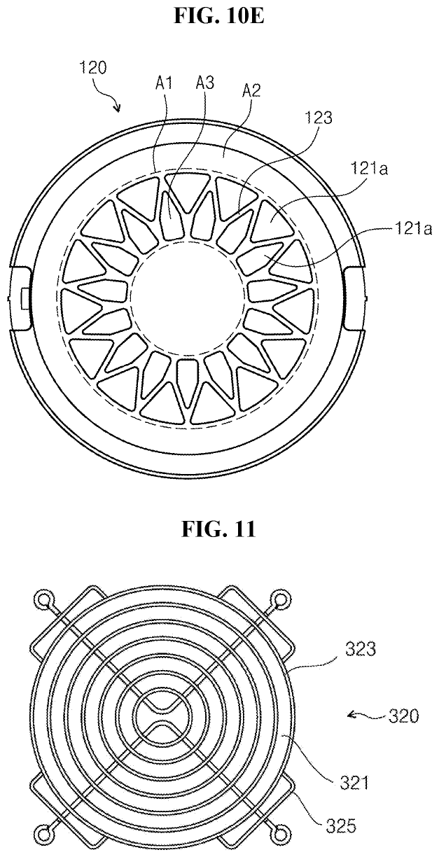

The upper insect passage unit 120 may be provided in various shapes. FIG. 10A to FIG. 10E are plan views of the upper insect passage unit 120 according to embodiments of the present invention.

Referring to FIG. 10A, in one embodiment, the frame 123 may be formed with one or more protrusions 123a protruding into the through-hole 121. The protrusions 123a may be formed on some frames 123 or on all of the frames 123, and the frames 123 may have the same or different numbers of protrusions 123a. The protrusions 123a may have various heights set in consideration of the area ratio of the total through-holes 121 and the size of the inscribed circle thereof.

In one embodiment, even in the case where the protrusions 123a of the frames 123 are provided to the through-hole 121, the inscribed circle of the through-hole 121 may have a maximum diameter of about 12 mm or less, about 10 mm or less, or about 7 mm or less. In this embodiment, when each of the frames 123 has the protrusions 123a, the inscribed circle is formed in each of the through-holes 121 to contact the protrusions 123a, thereby making it difficult for insects or other objects having a greater diameter than the inscribed circle to pass through the through-hole 121. Nevertheless, since the remaining region of the through-hole 121 excluding the protrusions 123a is a space penetrated in the vertical direction, the region of each of the through-holes 121 through which air can flow is not significantly reduced.

Referring to FIG. 10B, the through-holes 121 according to another embodiment may have various shapes and sizes. In FIG. 10B, the through-holes 121 are formed in a sector shape and have different sizes from one another.

Referring to FIG. 10C to FIG. 10E, the through-holes 121 according to a further embodiment may be formed in various shapes at various locations. In FIG. 10C and FIG. 10D, the through-holes 121 have a substantially trapezoidal or triangular shape.

In this embodiment, upper insect passage unit 120 includes a through-hole portion A1 including the through-holes 121, a surrounding portion A2 disposed outside the through-hole portion A1, and a central portion A3 disposed inside the through-hole portion A1 and not formed with the through-holes 121. The central portion A3 may correspond to a region in which and the motor is disposed instead of the blades of the fan. The flux or flow speed of air supplied by the fan is the lowest value on the central portion A3 at which a rotational axis of the blades is placed. On the other hand, since the flux or flow speed of air supplied by the fan is high in a region in which the blades are rotated, the through-holes 121 may be disposed in a region where the blades are disposed in order to improve insect trapping efficiency.

Referring again to FIG. 10E, the shapes of the through-holes 121 may be set in various ways so as to provide the maximum effect in a single area while maintaining the diameter of the inscribed circle and the area ratio of the through-holes 121 in the ranges set forth above. FIG. 10E shows through-holes having a triangular shape and a pentagonal shape.

FIG. 11 is a plan view of the lower insect passage unit 320 according to another embodiment of the present invention.

Referring to FIG. 11, the lower insect passage unit 320 may include a frame 323 defining through-holes 321 therein and an additional frame 325 provided to a gap between the fan and the frame 323. Even though the lower insect passage unit 320 has a diameter similar to or larger than the fan, a side surface of the fan can have a portion not covered by the lower insect passage unit 320 and an object having a predetermined size or more can be inserted into a gap between the fan and the lower insect passage unit 320. In this embodiment, in order to prevent this problem, the additional frame 325 may be disposed in the gap between the fan and the lower insect passage unit 320.

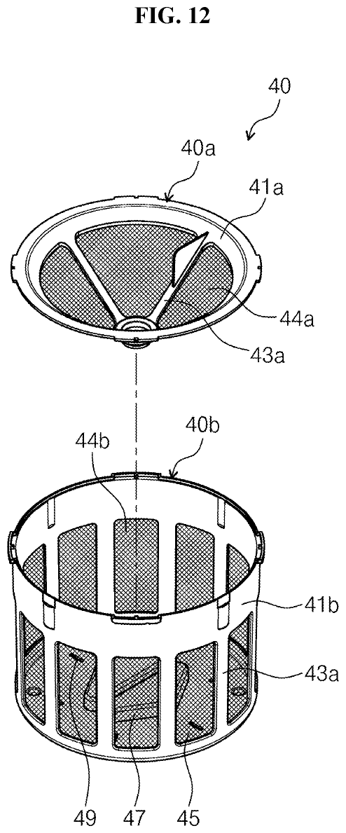

The trap unit is disposed under the insect passage unit and FIG. 12 is a perspective view of the trap unit.

Referring to FIG. 12, the trap unit 40 includes an upper trap unit 40a and a lower trap unit 40b fastened to each other to define an insect trapping space.

In other embodiments, the trap unit 40 may have an integral body design or may be provided as an assembled body.

The upper trap unit 40a may have a conical shape protruding in the downward direction and having a diameter gradually decreasing with increasing distance from the blowing unit 20. A portion of the upper trap unit 40a corresponding to a vertex of the conical shape is formed with an inlet through which insects can enter the trap unit 40. The upper trap unit 40a may include a fastening unit 41a fastened to the lower trap unit 40b and/or the housing 30 (see FIG. 2), ribs 43a connected to the fastening unit 41a to define a substantial shape of the upper trap unit 40a, and a mesh portion 44a provided between the ribs 43a.

The lower trap unit 40b surrounds a portion of the insect trapping space excluding the upper trap unit 40a so as to define the insect trapping space together with the upper trap unit 40a. The lower trap unit 40b may include a fastening unit 41b fastened to the upper trap unit 40a and/or the housing 30 (see FIG. 2), a lower surface 45 formed with a gripper 47 to be gripped by a user, ribs 43a, and a mesh portion 44b provided between the ribs 43a. The lower surface 45 may be formed with a drainage port 49 through which water can be discharged.

In some embodiments, the trap unit 40 may be assembled to allow detachment of at least some components therefrom. In one embodiment, the upper trap unit 40a and the lower trap unit 40b may be simultaneously detached from the trap unit 40, and in other embodiments, only the lower trap unit 40b may be detached therefrom. In other embodiments, the lower trap unit 40b may be provided with a separate door. Accordingly, when a predetermined volume of insects is collected in the trap unit 40, at least part of the trap unit 40 is separated from the housing 30 to remove the collected insects.

Although not shown in the drawings, the trap unit 40 according to one embodiment may be provided with an insecticide sprayer to kill insects collected therein. The insecticide sprayer contains an insecticide capable of killing the insects collected in the trap unit 40 and sprays the insecticide to prevent loss of the insects captured in the trap unit 40.

Although not shown in the drawings, the insect trap according to some embodiments may further include components for sterilization, purification and deodorization in addition to the insect trapping effect and the insect killing effect. For example, the insect trap according to one embodiment may include a photocatalyst material. Specifically, the insect trap may include the photocatalyst material coated onto or bonded to the inner surface of the housing, the upper surface of the blowing unit, and the like, or may include a separate photocatalyst filter including the photocatalyst material. The photocatalyst material for the photocatalyst filter generates photocatalytic reaction by light emitted from the light source part and may include titanium oxide (TiO₂), zinc oxide (ZnO), tin oxide (SnO₂), and the like.

In addition, the drive unit of the insect trap according to one embodiment may further include a controller having various functions to control emission of light having different wavelengths depending upon the kind of insect, the intensity of light depending upon the amount of insects, on/off or flickering of the light sources, and the like.

Further, the insect trap according to one embodiment may further include a light quantity sensor, which senses the intensity of external light to control the intensity of light emitted from the light source part or senses the intensity of light emitted from the light source part to determine replacement of the light source part.

With the structure described above, the insect trap can effectively capture insects and the light sources of the light source part emit light at a broader angle than a typical insect trap, thereby improving an insect attraction effect.

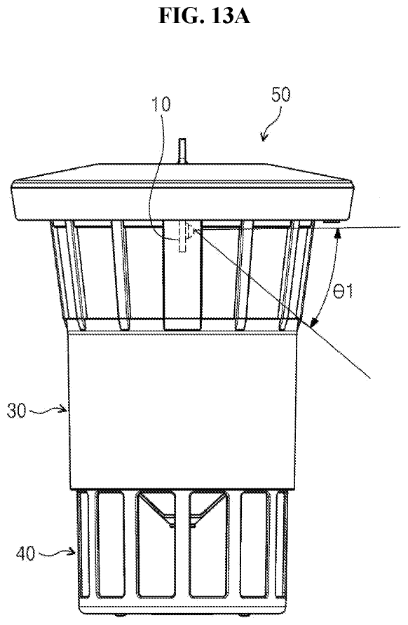

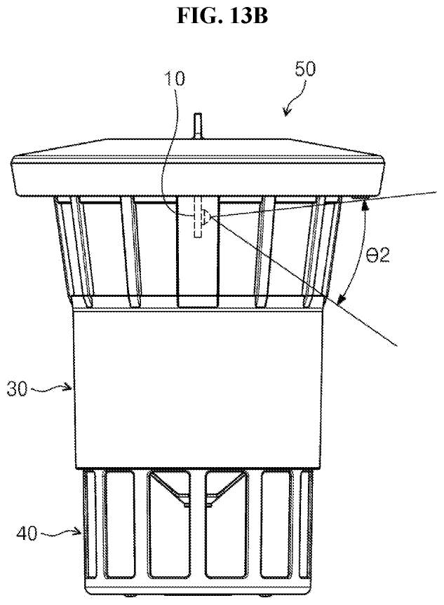

FIG. 13A and FIG. 13B are side views of an insect trap having a typical light source part and an insect trap according to one embodiment of the present invention, respectively, illustrating an irradiation angle of light emitted from each of the light source part.

Referring to FIG. 13A, in the typical light source part 10, a light source unit is mounted on a light source cover and substantially contacts the rear surface of the light source cover. In this structure, the maximum emission angle of light from the light source part 10 is a first angle θ1, as shown in the drawing. The first angle corresponds to an angle between a line extending from the light source part 10 to the main body of the housing 30 and a line extending from the light source part 10 to be substantially parallel to a rear surface of a plate of the light source support.

Referring to FIG. 13B, in the light source part 10 according to the embodiment, the first spacers are mounted on the light source cover to separate the light source unit from the light source cover or the rear surface of the light source support by a predetermined distance in the downward direction. In this structure, the maximum emission angle of light from the light source part 10 is a second angle θ2, as shown in the drawing. The second angle corresponds to an angle between a line extending from the light source part 10 to the main body of the housing 30 and a line extending from the light source part 10 to an end of the light source support.

Here, the line extending from the light source part 10 to the end of the light source support is oblique with respect to the rear surface of the light source support and the second angle θ2 is greater than the first angle θ1. That is, the insect trap according to the embodiment has a larger light emission angle than the typical insect trap. With this structure, the insect trap according to the embodiment has an improved insect attraction effect.

Here, the separation distance of the light source unit from the rear surface of the light source support is set to provide the maximum light emission angle.

Furthermore, according to one embodiment of the invention, the light source unit is disposed at a location ensuring a predetermined flux of air or more. The distance between the light source support and the light source unit can be easily changed through regulation of the length of the first spacers.

Although insects fly by own efforts when air flows at a predetermined speed or less (for example, about 0.5 m/s), the insects tend to fly corresponding to movement of air instead of flying by own efforts within a predetermined air flow speed range. Accordingly, in order to capture insects without allowing escape of the insects using the flow of air generated by the blowing unit, it is desirable that air directed to the trap unit have a flow speed of about 0.5 m/s or more.

However, the flow speed of air increases as the air approaches the blowing unit and decreases as the air moves away from the blowing unit. In particular, the flow speed is significantly reduced near the rear surface of the light source support due to an eddy caused by the light source support. Accordingly, the light sources attracting insects may be separated from the light source support by a predetermined distance instead of being placed close to the light source support in order to ensure a predetermined air flow speed or more near the light sources, thereby improving insect trapping efficiency. For example, according to one embodiment, when the substrate of the light source unit is separated from the light source support in the downward direction by a predetermined distance (for example, about 16 mm), the flow speed may be 0.5 m/s or more.

However, since the light source unit excessively protruding from the light source support can obstruct the flow of air, the location of the light source unit may be set so as not to obstruct the flow of air from the air inlet towards the air outlet.

As described above, the insect trap according to the embodiments of the invention can easily adjust the air flow speed and the irradiation angle through adjustment of the distance between the light source support and the light source unit using the first spacers, thereby improving insect trapping efficiency.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

1. An insect trap comprising:
a light source configured for emitting light configured for attracting insects;
a blower disposed adjacent to the light source;
a housing comprising an air inlet and an air outlet and receiving the blower;
a trap fastened to the housing at a side of the air outlet;
a cover fastened to the housing and covering the light source; and
a first waterproof member disposed between the housing and the cover.

2. The insect trap according to claim 1, wherein the blower comprises:
a fan disposed under the light source; and
a first insect passage disposed between the fan and the light source and comprising a frame defining a through-hole through which insects are configured to pass,
the through-hole occupying an area of 20% to 99% of a total area of the first insect passage in plan view.

3. The insect trap according to claim 2, wherein the through-hole has an inscribed circle having a maximum diameter greater than an average size of the insects.

4. The insect trap according to claim 2, wherein the frame comprises protrusions protruding into the through-hole.

5. The insect trap according to claim 3, wherein the inscribed circle of the through-hole has a maximum diameter of 12 mm or less.

6. The insect trap according to claim 5, wherein the inscribed circle of the through-hole has a diameter of 7 mm to 12 mm.

7. The insect trap according to claim 6, wherein the through-hole is provided in plural and the first insect passage comprises a through-hole portion in which the through-holes are formed and a central portion in which the through-holes are not formed, the central portion being disposed corresponding to a center of rotation of the fan.

8. The insect trap according to claim 2, further comprising:
a second insect passage disposed between the fan and the trap and comprising a frame defining a through-hole through which insects are configured to pass.

9. The insect trap according to claim 8, wherein the second insect passage has a different shape from the first insect passage.

10. The insect trap according to claim 8, wherein, in the second insect passage, the through-hole occupies an area of 50% to 99% of a total area of the second insect passage.

11. The insect trap according to claim 1, wherein the first waterproof member has a closed-figure shape disposed along an end of the housing.

12. The insect trap according to claim 1, further comprising:
a light source support on which the light source is mounted, the light source support being fastened to the housing at a side of the air inlet; and
a second waterproof member disposed between the housing and the light source support.

13. The insect trap according to claim 12, wherein the second waterproof member has a closed-figure shape disposed along an end of the light source support.

14. The insect trap according to claim 12, wherein the light source comprises:
a light source unit comprising at least one light source element emitting the light and a substrate on which the light source element is mounted;
a light source case receiving the light source unit; and
a light source cover covering the light source case.

15. The insect trap according to claim 14, wherein the light source case has an interior space open at one side thereof to receive the light source unit, and the light source cover supports the substrate and comprises a first spacer separating the substrate from the light source cover.

16. The insect trap according to claim 15, wherein the first spacer separates the light source unit from a rear surface of the light source support by a predetermined distance.

17. The insect trap according to claim 16, wherein the light source is configured to emit the light in a lateral direction of the housing and the predetermined distance is set to allow the light to be emitted at a maximum angle between the cover and the housing.

18. The insect trap according to claim 15, wherein the light source cover further comprises a second spacer protruding from a rear surface thereof and maintaining a separation distance between the light source cover and the light source case.

19. The insect trap according to claim 14, wherein the light source unit further comprises a connector disposed on the substrate and connecting the light source element to an interconnect line, and the light source cover further comprises a shield protruding from a rear surface of the light source cover and covering the connector.

20. The insect trap according to claim 19, wherein the shield comprises an ultraviolet light (UV) blocking agent.

21. The insect trap according to claim 1, wherein the blower comprises a fan configured for forcing air having passed through the air inlet to flow towards the air outlet.

22. An insect trap comprising:
a light source configured for emitting light configured for attracting insects;
a fan disposed under the light source;
a first insect passage disposed between the fan and the light source and comprising a frame defining a through-hole through which the insects are configured to pass;
a housing comprising an air inlet and an air outlet and receiving the fan and the first insect passage;
a trap fastened to the housing at a side of the air outlet; and
a cover fastened to the housing and covering the light source, wherein the through-holes occupy an area of 20% to 99% of a total area of the first insect passage in plan view.
